(19) United States
(12) Patent Application Publication
(10) Pub. No.: US 2019/0031384 A1
(43) Pub. Date: Jan. 31, 2019

(54) METHOD OF PACKING A VEHICLE IN A CRATE FOR SHIPMENT

(71) Applicant: BOMBARDIER RECREATIONAL PRODUCTS INC., Valcourt (CA)

(72) Inventors: Simon FILION, St-Paul-d'Abbotsford (CA); Jean GUILLEMETTE, Valcourt (CA)

(21) Appl. No.: 15/681,943

(22) Filed: Aug. 21, 2017

Related U.S. Application Data
(60) Provisional application No. 62/538,922, filed on Jul. 31, 2017.

(51) Int. Cl. B65B 63/02; B65B 5/04; B65B 61/20

(52) U.S. Cl. CPC B65B 63/02; B60G 3/18; B65B 61/20; B65B 5/04

(57) ABSTRACT

A method of packing a vehicle in a crate for shipment is disclosed where a full vehicle height is greater than an internal height of the crate. The method includes placing the vehicle on a bottom side of the crate; compressing the vehicle into a packing configuration by compressing front and rear suspension assemblies; and connecting crate side walls and a top side of the crate to the crate bottom, the internal height being measured from a top surface of the bottom side of the crate to the top side of the crate, the top surface of the bottom side of the crate to a highest point of a roll cage being less than or equal to the internal height when the vehicle is in the packing configuration and is placed on the bottom side of the crate, the roll cage and tires still being installed on the vehicle.

### CROSS-REFERENCE

The present application claims priority to U.S. Provisional Patent Application No. 62/538,922, entitled “Method Of Packing A Vehicle In A Crate For Shipment,” filed Jul. 31, 2017, the entirety of which is incorporated herein by reference.

### FIELD OF TECHNOLOGY

The present technology relates to a method of packing a vehicle in a crate for shipment.

### BACKGROUND

There exist various types of vehicles used mainly in off-road conditions. One such type is the side-by-side off-road vehicle. The name “side-by-side” refers to the seating arrangement of the vehicle in which the driver and a passenger are seated side-by-side. Some side-by-side off-road vehicles also have a second row of seats to accommodate one or more additional passengers. These vehicles typically have an open cockpit, a roll cage and a steering wheel.

Such vehicles are generally shipped in crates after assembly to dealerships. These crates are sized to be stacked two high, in order to minimize overall shipping costs. Due to physical and regulatory limitations in shipping, there is a maximum height of such crates in order to be double stacked. In order to fit in the maximum height of these crates, vehicles are often partially disassembled, for example by removing vehicle wheels and/or roll cages.

For vehicles that are partially disassembled, removed portions such as wheels and roll cages will still need to be packaged and shipped, either separately, or in the same crate. In some situations, the crate may need to be elongated in order to adhere to the maximum height for double stacking of the crates while also still providing enough volume to pack the additional parts in the crate with the vehicle. Alternatively, in some vehicles, portions that are normally separated for shipping may not be easily removed for packing at all. For example, some such side-by-side vehicles have a roll cage which is welded to the vehicle frame.

Removing vehicle wheels and roll cages, when possible, can increase costs, time, and waste as removed portions often need to be wrapped separately to protect the portions during shipping. Removing portions of the vehicle also increases costs and complexity for the receiving dealerships, as the wheels and roll cages need to be re-installed on the vehicles before they are ready for use or for sale. This also can increase costs, as additional handling of the vehicle increases the likelihood of damaging the vehicles before they are sold.

Thus there is a desire for a method of packing vehicles in crates of limited size for shipment, while limiting disadvantages related to traditional methods of fitting vehicles into crates and decreasing complexity of preparation of the vehicles by the receiving dealerships.

### SUMMARY

It is an object of the present technology to ameliorate at least some of the inconveniences present in the prior art.

According to one aspect of the present technology, there is provided a method of packing a vehicle in a crate for shipment, the vehicle having a full vehicle height greater than an internal height of the crate. The method includes placing the vehicle on a bottom side of the crate; compressing the vehicle into a packing configuration by compressing two front suspension assemblies of the vehicle and two rear suspension assemblies of the vehicle; and connecting a plurality of crate side walls and a top side of the crate to the crate bottom, the internal height being measured from a top surface of the bottom side of the crate to the top side of the crate, a distance from the top surface of the bottom side of the crate to a highest point of a roll cage of the vehicle is less than or equal to the internal height of the crate when the vehicle is in the packing configuration and is placed on the top surface of the bottom side of the crate, the roll cage and a plurality of tires being installed on the vehicle when the vehicle is in the packing configuration.

In some implementations, compressing the two front suspension assemblies and the two rear suspension assemblies includes installing and using a tie-down strap on each of the suspension assemblies.

In some implementations, the compressing the two front suspension assemblies and the two rear suspension assemblies includes connecting a first front tie-down strap between a first front suspension assembly of the two front suspension assemblies and a frame of the vehicle; connecting a second front tie-down strap between a second front suspension assembly of the two front suspension assemblies and the frame of the vehicle; connecting a first rear tie-down strap between a first rear suspension assembly of the two rear suspension assemblies and the frame of the vehicle; connecting a second rear tie-down strap between a second rear suspension assembly of the two rear suspension assemblies and the frame of the vehicle; tightening the first front tie-down strap to compress the first front suspension assembly; tightening the second front tie-down strap to compress the second front suspension assembly; tightening the first rear tie-down strap to compress the first rear suspension assembly; and tightening the second rear tie-down strap to compress the second rear suspension assembly.

In some implementations, for the first front tie-down strap and the second front tie-down strap, the connecting the tie-down strap includes looping a bottom end of a webbing of the tie-down strap around a portion of an A-arm of the corresponding front suspension assembly, and connecting a ratchet head of the tie-down strap to a corresponding one of a first front peg and a second front peg disposed on the frame of the vehicle at least partially vertically above the corresponding front suspension assembly; for the first rear tie-down strap and the second rear tie-down strap, the connecting the tie-down strap includes looping a bottom end of a webbing of the tie-down strap around a portion of a trailing arm of the corresponding rear suspension assembly, and connecting a ratchet head of the tie-down strap to a corresponding one of a first rear peg and a second rear peg disposed on the frame of the vehicle at least partially vertically above the corresponding rear suspension assembly; and tightening each of the first front tie-down strap, second front tie-down strap, first rear tie-down strap, and second rear tie-down strap includes using the corresponding ratchet head to wind the webbing around a spool of the ratchet head, thereby drawing the ratchet head and the bottom end toward each other.

In some implementations, the tightening of the first front tie-down strap, second front tie-down strap, first rear tie-down strap, and second rear tie-down strap includes only partially winding the corresponding webbing; and the method further includes repeating the partial winding of the first front tie-down strap, second front tie-down strap, first rear tie-down strap, and second rear tie-down strap until the front and rear suspension assemblies are compressed and the vehicle is in the packing configuration.

In some implementations, an undercarriage of the vehicle abuts the bottom side of the crate when the front suspension assemblies and the rear suspension assemblies are compressed and the vehicle is in the packing configuration.

In some implementations, the vehicle is in the packing configuration when the front and rear suspension assemblies abut a plurality of suspension stoppers of the vehicle.

In some implementations, the method further includes deflating at least two tires of the vehicle.

In some implementations, the method further includes connecting a protective plate to the roll cage of the vehicle.

In some implementations, the method further includes connecting the vehicle by at least one plastic strap to at least one of the plurality of crate side walls and the bottom side of the crate.

In some implementations, an exterior height of the crate is about 52 inches/132 centimeters; and the distance from the top surface of the bottom side of the crate to the highest point of the roll cage of the vehicle is equal to or less than 50 inches/127 centimeters.

In some implementations, an exterior height of the crate is less than or equal to half of a pre-determined maximum shipping height.

In some implementations, when the vehicle is in the packing configuration, the roll cage and the plurality of tires are connected to the vehicle in their operational arrangement.

In some implementations, the placing the vehicle on a bottom side of the crate includes placing at least one tire of the plurality of tires partially into at least one aperture in the bottom side of the crate such that at least a portion of the at least one tire extends below the top surface of the bottom side of the crate.

In some implementations, the placing the vehicle on a bottom side of the crate includes placing each tire of the plurality of tires at least partially into one of a plurality of apertures in the bottom side of the crate such that at least a portion of each tire extends below the top surface of the bottom side of the crate.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Explanations and/or definitions of terms provided in the present application take precedence over explanations and/or definitions of these terms that may be found in any documents incorporated herein by reference.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an off-road side-by-side vehicle;

FIG. 2 is a front elevation view of the vehicle of FIG. 1;

FIG. 3 is a rear elevation view of the vehicle of FIG. 1;

FIG. 4 is a front elevation view of front suspension assemblies and associated frame portions of the vehicle of FIG. 1;

FIG. 5 is a left side elevation view of a frame, seats, a steering assembly, front wheels, front suspension assemblies, rear suspension assemblies and other components of the vehicle of FIG. 1, with the front and rear suspension assemblies being in a position corresponding to the vehicle being unloaded and on level ground;

FIG. 6A is a left side elevation view of the vehicle of FIG. 1 in a packing configuration and enclosed in a crate for shipment;

FIG. 6B is the left side elevation view of the vehicle and the crate of FIG. 6B, with a plastic cover installed on the crate;

FIG. 7A is a top, rear, right side perspective view of the crate for shipment of FIG. 6A;

FIG. 7B is a top, rear, right side perspective view of a bottom side of the crate for shipment of FIG. 7A;

FIG. 8 is the left side elevation view of the vehicle and crate of FIG. 6A, with a portion of the crate having been removed;

FIG. 9 is a rear side elevation view of the vehicle in the crate of FIG. 6A;

FIG. 10 is a left side elevation view of the vehicle in the packing configuration of FIG. 6A, with the crate having been removed;

FIG. 11 is a cross-sectional view of the vehicle in the packing height configuration of FIG. 10, taken along line 11-11 of FIG. 10, with some components having been removed;

FIG. 12 is a cross-sectional view of the vehicle in the packing height configuration of FIG. 10, taken along line 12-12 of FIG. 10, with some components having been removed;

FIG. 13 is a front, right side perspective view of a tie-down strap used to compress the vehicle of FIG. 1 into the packing configuration of FIG. 6; and

FIG. 14 is a flow-chart of a method of packing the vehicle of FIG. 1 in the crate of FIG. 6.

### DETAILED DESCRIPTION

The present technology is described herein with respect to a four-wheel off-road vehicle 10 having two side-by-side seats and a steering wheel. However, it is contemplated that some aspects of the present technology may apply to other types of vehicles such as, but not limited to, vehicles having more or less than four wheels, off-road vehicles having ground engaging members other than wheels, and off-road vehicles having more or less than two seats.

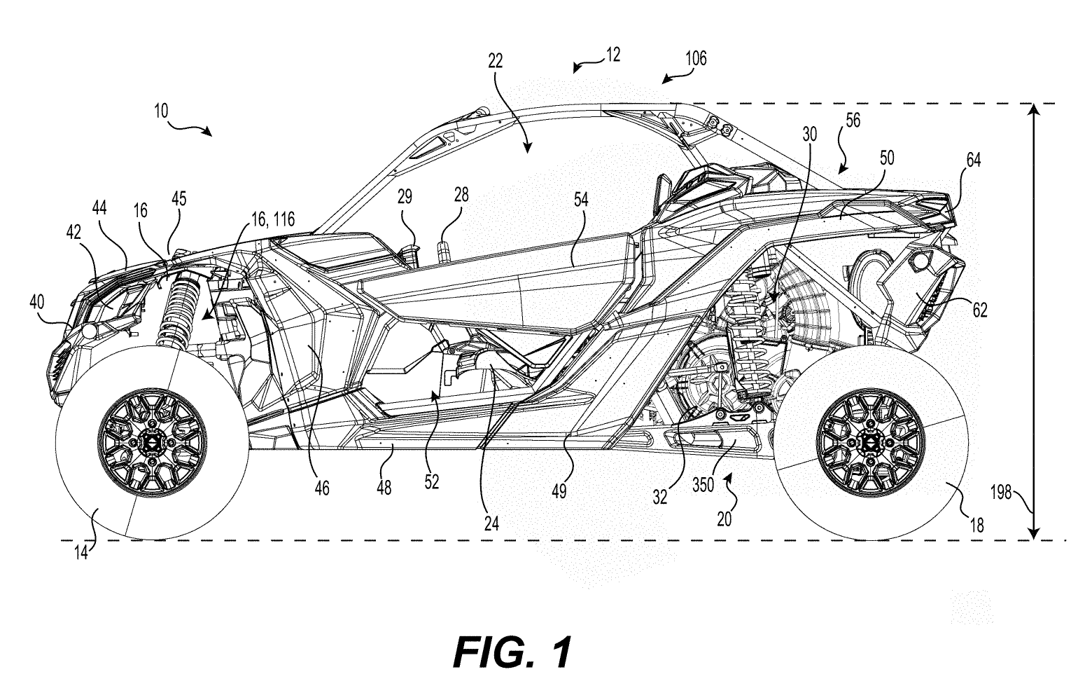

The general features of the off-road vehicle 10 will be described with respect to FIGS. 1 to 5. The vehicle 10 has a frame 12, two front wheels 14 connected to a front of the frame 12 by front suspension assemblies 16 and two rear wheels 18 connected to the frame 12 by rear suspension assemblies 20. The front suspension assemblies 16 and the rear suspension assemblies 20 will be described in greater detail below.

The frame 12 is made from a plurality of hollow cylindrical steel members and steel brackets that are welded to each other. A roll cage 106 made from a plurality of hollow cylindrical steel members and steel brackets that are welded to each other is welded to an upper portion of the frame 12. It is contemplated that at least some of the hollow cylindrical members of the frame 12 and the roll cage 106 could be replaced by other types of members such as solid cylindrical members, hollow tubes having a cross-section other than circular, and beams, for example. It is also contemplated that the members and brackets could be made of another type of metal, such as aluminum for example. It is also contemplated that at least some of the members and brackets could be made of a non-metallic material, such as composite materials or plastics for example. It is also contemplated that at least some of the members and brackets could be joined to each other by means other than welding, such as by fastening and bonding for example.

The frame 12 defines a central cockpit area 22 inside which are disposed a driver seat 24 and a passenger seat 26. The roll cage 106 defines a top side of the cockpit area 22. In the present implementation, the driver seat 24 is disposed on the left side of the vehicle 10 and the passenger seat 26 is disposed on the right side of the vehicle 10. However, it is contemplated that the driver seat 24 could be disposed on the right side of the vehicle 10 and that the passenger seat 26 could be disposed on the left side of the vehicle 10.

A steering wheel 28 is disposed in front of the driver seat 24. The steering wheel 28 is used to turn the front wheels 14 to steer the vehicle 10. Various displays and gauges 29 are disposed above the steering wheel 28 to provide information to the driver regarding the operating conditions of the vehicle 10. Examples of displays and gauges 29 include, but are not limited to, a speedometer, a tachometer, a fuel gauge, a transmission position display, and an oil temperature gauge.

As can be seen in FIG. 1, a motor 30 is connected to the frame 12 in a rear portion of the vehicle 10. In the present implementation, the motor 30 is an in-line, three-cylinder, four-stroke internal combustion engine 30. It is contemplated that other types of internal combustion engines could be use, such as a V-twin or a two-stroke internal combustion engine for example. It is also contemplated that in some implementations, the engine 30 could be replaced by another type of motor such as a diesel engine or an electric motor for example. The engine 30 is connected to a continuously variable transmission (CVT) 32 disposed on a left side of the engine 30. The CVT 32 is operatively connected to a transaxle (not shown) to transmit torque from the engine 30 to the transaxle disposed behind the engine 30. The trans axle is operatively connected to the front and rear wheels 14, 18 to propel the vehicle 10.

The vehicle 10 includes body panels connected to the frame 12. The panels help protect the internal components of the vehicle 10 and provide some of the aesthetic features of the vehicle 10. Front panels 40 are connected to a front of the frame 12. The front panels 40 are disposed forward of the front suspension assemblies 16 and laterally between the front wheels 14. The front panels 40 define two apertures inside which the headlights 42 of the vehicle 10 are disposed. A cover 44 extends generally horizontally reward from a top of the front panels 40. The cover 44 defines an aperture 45 through which tops of the front suspension assemblies 16 protrude.

Front fenders 46 are disposed rearward of the front panels 40 on each side of the vehicle 10 and are disposed in part above and in part behind of its corresponding front wheel 14. Lower panels 48 extend along the bottom of the frame 12 between the front and rear wheels 14, 18. A generally L-shaped panel 49 is disposed behind the rear end of each lower panel 48. Generally L-shaped rear fenders 50 extend upward and then rearward from the rear, upper ends of the L-shaped panels 49. Each rear fender 50 is disposed in part above and in part forward of its corresponding rear wheel 18. The rear fenders 50 define apertures at the rear thereof to receive the brake lights 64 of the vehicle 10. It is contemplated that the brake lights 64 could be replaced with reflectors or that reflectors could be provided in addition to the brake lights 64.

On each side of the vehicle 10, the front fender 46, the lower panel 48, the L-shaped panel 49 and the rear fender 50 define a passage 52 through which a driver (or passenger depending on the side of the vehicle 10) can enter or exit the vehicle 10. Each side of the vehicle 10 is provided with a door 54 that selectively closes an upper portion of the corresponding passage 52.

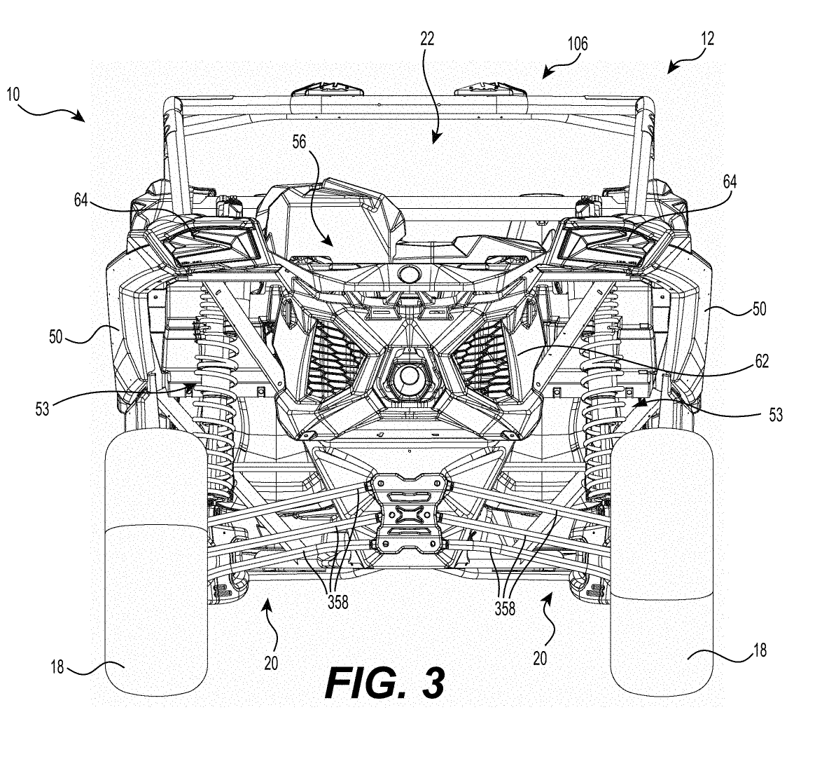

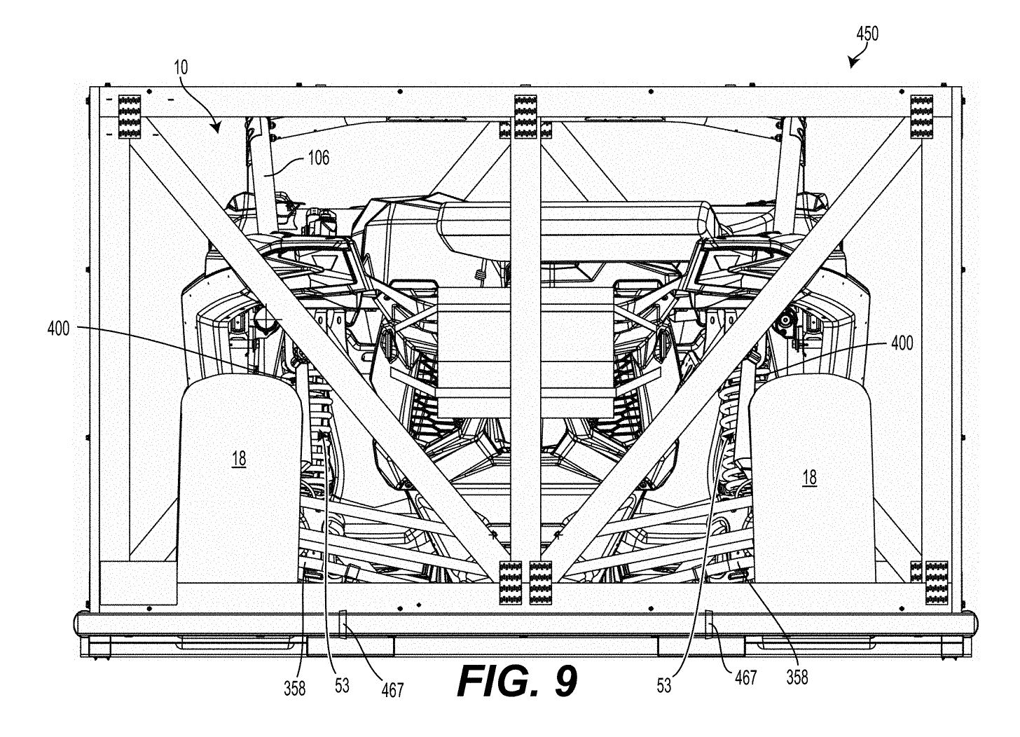

As best seen in FIG. 3, the rear fenders 50 define a cargo space 56 therebetween behind the seats 24, 26. Best seen in FIG. 9, the cargo space 56 has a floor 58 extending horizontally between the rear fenders 50. A separation panel 60 extends laterally and is disposed longitudinally between the seats 24, 26 and the floor 58. As a result, the separation panel 60 separates the cockpit area 22 from the cargo area 56. A rear facia panel 62 is disposed laterally between the rear wheels 18 behind the floor 58.

With reference to FIGS. 1, 2, and 4, the front suspension assemblies 16 will now be described in further detail. As the left and right front suspension assemblies 16 are mirror images of each other, only the right front suspension assembly 16 will described in detail. Components of the left front suspension assembly 16 that correspond to those of the right front suspension assembly 16 have been labeled with the same reference numerals in the figures.

The front suspension assembly 16 is a double A-arm suspension assembly. The front suspension assembly 16 has a lower A-arm 250, an upper A-arm 252 and a shock absorber assembly 116. The shock absorber assembly 116 includes a coil spring disposed around a hydraulic shock, and the hydraulic shock has a separate reservoir connected to it. The shock absorber assembly 116 includes a rubber suspension stopper 118 disposed within the coil spring. Since shock absorber assemblies of this type are well known, the shock absorber assembly 116 will not be described in greater detail.

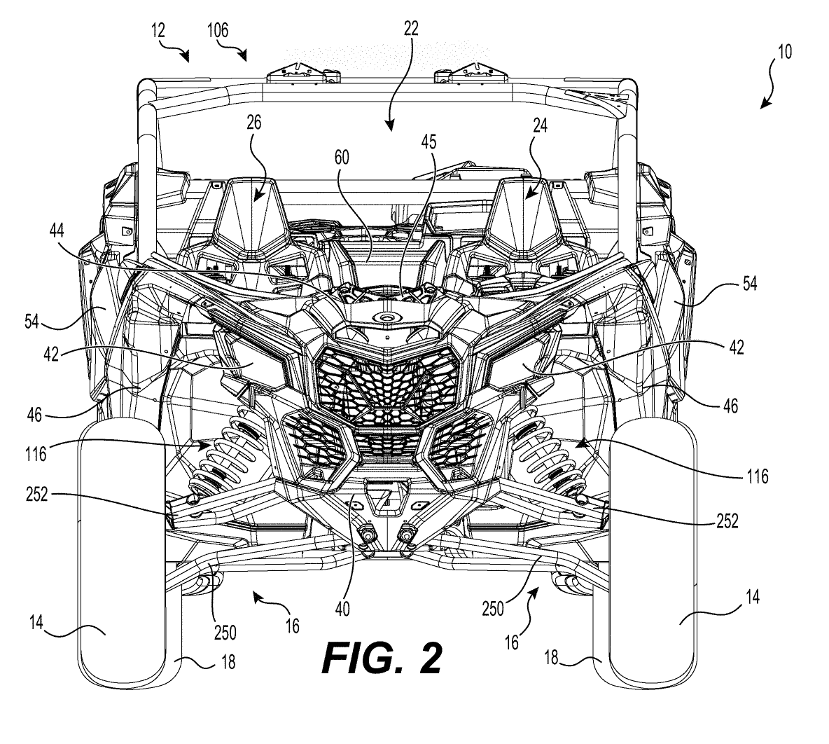

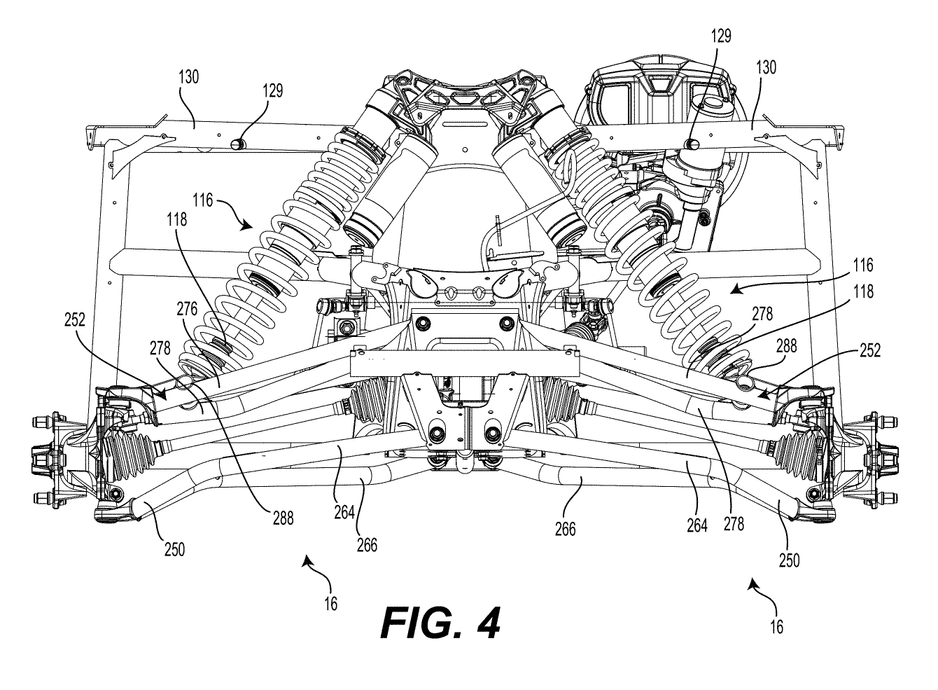

As can be seen in at least FIGS. 2 and 4, the lower A-arm 250 has a front arm 264 and a rear arm 266. Similarly, the upper A-arm 252 has a front arm 276 and a rear arm 278. A cross-member 280 is connected between the front and rear arms 276, 278. A shaft 288 is connected to the top of the front and rear arms 276, 278 near their laterally outward ends. The shaft 288 pivotally connects the lower end of the shock absorber assembly 116 to the upper A-arm 252. From its lower end, the shock absorber assembly 116 extends upward, rearward and laterally inward to the upper end of the shock absorber assembly 116 pivotally connected to the frame 12. The shock absorber assemblies 116 extend through the aperture 45 in the cover 44 of the vehicle 10.

Additional details relating to the front suspension assemblies 16 can be found in U.S. Patent Publication No. 2016/0347137 A1, entitled “Rear Suspension Assembly for an Off-road Vehicle,” published Dec. 1, 2016, the entirety of which is incorporated herein by reference.

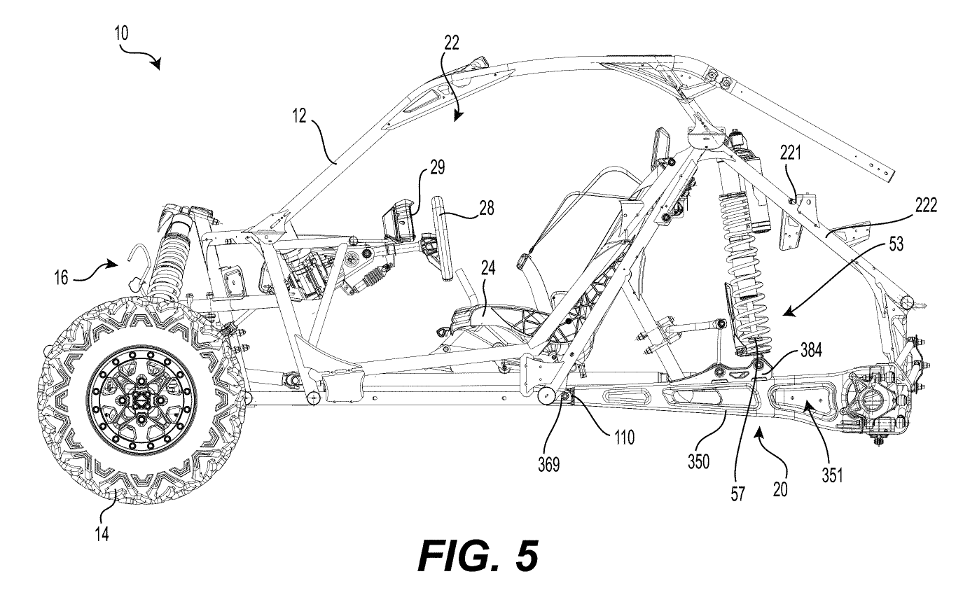

Turning now to FIGS. 3 and 5, the rear suspension assemblies 20 will be described in more detail. As the left and right rear suspension assemblies 20 are mirror images of each other, only one rear suspension assembly 20 will described in detail.

The rear suspension assembly 20 includes a trailing arm 350, three links 358 connected to the trailing arm 350, and a shock absorber assembly 53. The trailing arm 350 is pivotally connected at its front end to a bracket 110 of the frame 12 by a ball joint 369. The shock absorber assembly 53 includes a coil spring disposed around a hydraulic shock, and the hydraulic shock has a separate reservoir connected to it. The shock absorber assembly 53 includes a rubber suspension stopper 57 disposed within the coil spring. Since shock absorber assemblies of this type are well known, the shock absorber assembly 53 will not be described in greater detail. The lower end of the shock absorber assembly 53 is pivotally connected to the trailing arm 350 by a ball joint (not shown) via the bracket 384. From the bracket 384, the shock absorber assembly 53 extends upward, forward and laterally inward. The upper end of the shock absorber assembly 53 is pivotally connected to the frame 12.

Additional details relating to the rear suspension assemblies 20 are also described in U.S. Patent Publication No. 2016/0347137 A1, mentioned above.

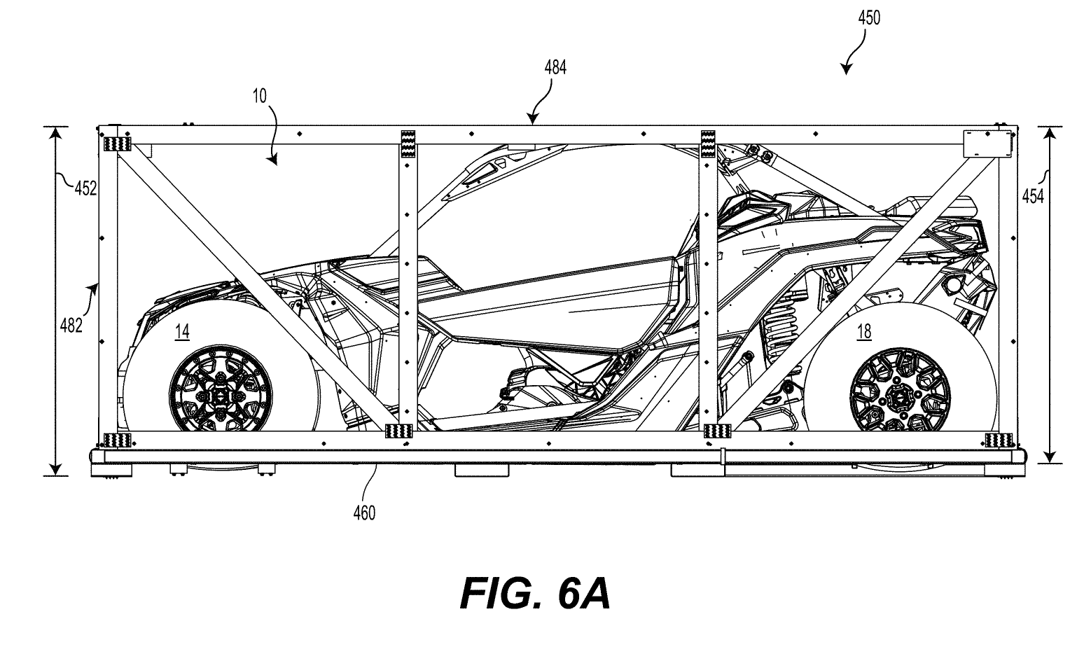

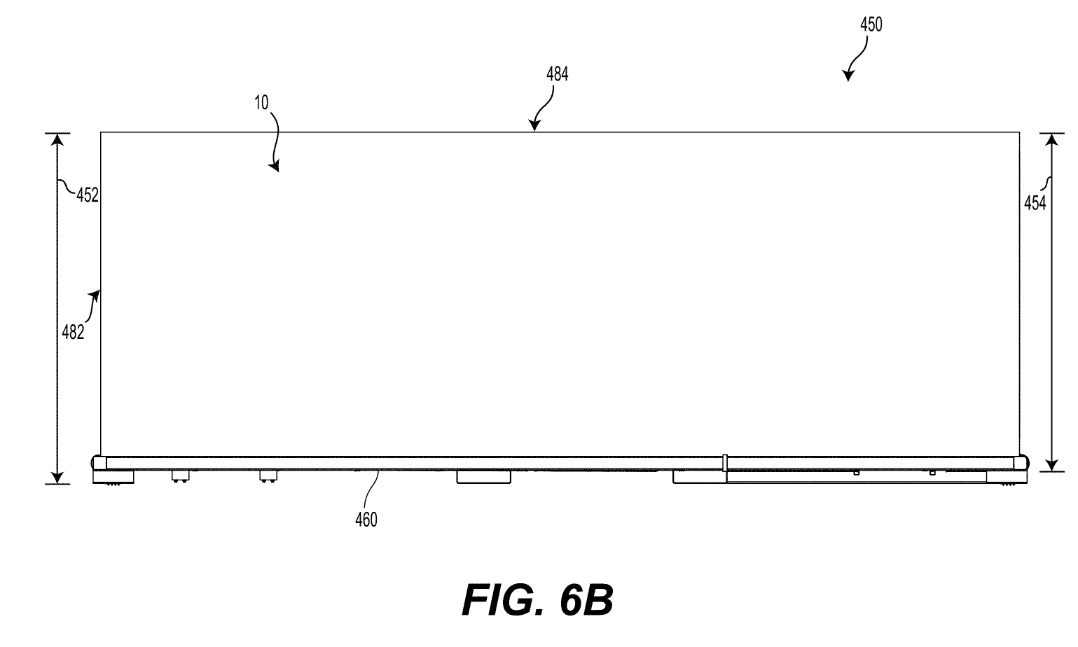

With reference to FIGS. 6A to 13, packing the vehicle 10 for shipment will now be described. The vehicle 10, and similar such vehicles, are generally shipped in crates, such as the crate 450 illustrated in FIGS. 6A to 8. The crate 450 is sized to be stacked on top of an identically sized crate 450, where the height of the two crates 450 stacked one on top of the other does not exceed a pre-determined maximum shipping height. In the present implementation, the crates 450 once stacked are sized not to exceed the maximum shipping height of 104 inches (about 264 centimeters) in accordance with a standard ISO 668, 1AAA container, which has a maximum internal height of 265.5 centimeters. It is contemplated that the crates 450 could be sized to comply with different or multiple specific restrictions for different modes of shipment or changes in transport regulation. The crate 450 therefore must have an exterior height 452 (see FIG. 6A) which is equal to or less than 52 inches (132 centimeters). The exterior height 452 is 52 inches in the present implementation.

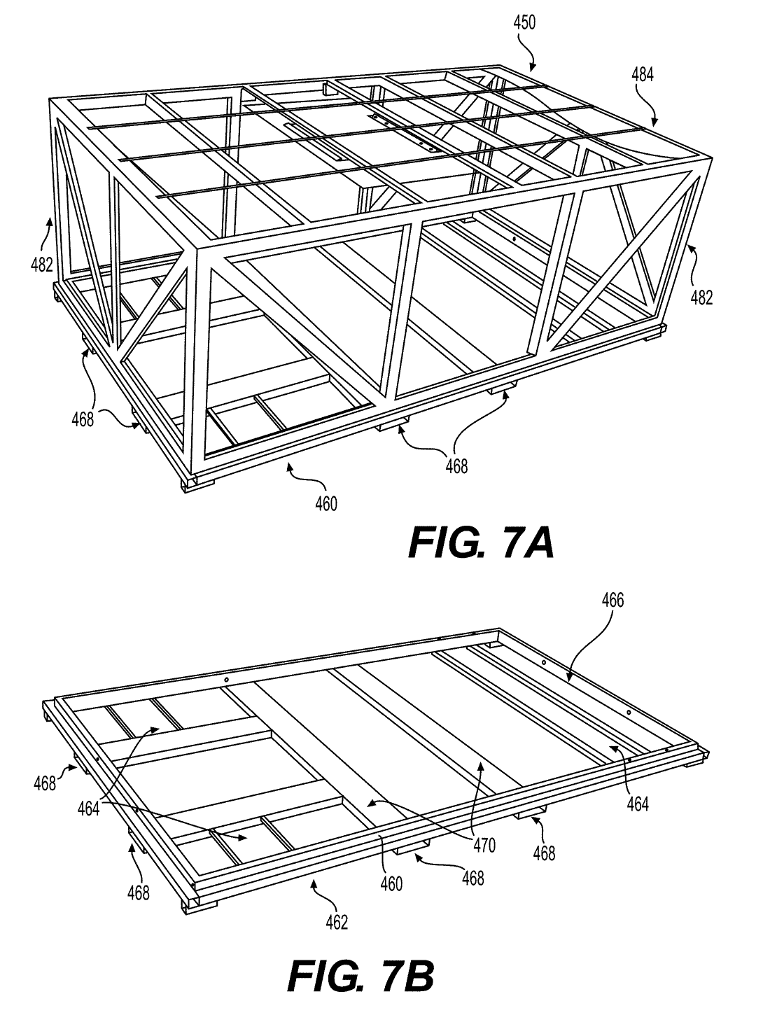

The crate 450 includes a bottom side 460, illustrated in more detail in FIGS. 7A and 7B. The vehicle 10 is placed on and supported by the bottom side 460 when packed in the crate 450. The bottom side 460 is made of a steel frame 462 upon which a wood rim 466 is connected. It is contemplated that the bottom side 460 could be made from more or fewer different materials, depending on the implementation. The bottom side 460, specifically the steel frame 462, includes three apertures 464 in which the wheels 14, 18 of the vehicle 10 are located when the vehicle 10 is placed on the bottom side 460, as will be described in more detail below. The steel frame 462 also includes four rectangular tubes 468, two extending across the width of the bottom side 460, and two extending from a rear side of the crate 450. These tubes 468 can be used by a forklift to move the crate 450, as well as the vehicle 10 and the crate 450 when the vehicle 10 is packed. The tubes 468 extending across the width of the bottom side 460 further provide weight bearing surfaces 470 on which most of the weight of the vehicle 10 will rest when the vehicle 10 is fully packed in the crate 450, as will be described in more detail below.

The crate 450 also includes four side walls 482, and a top side 484 connected to the four side walls 482. The side walls 482 and the top side 484 are made from a plurality of wood members fastened together, although it is contemplated that the walls 482 and the top side 484 could be made from one or more materials other than wood. The side walls 482 and the top side 484 are connected to the bottom side 460 to close the crate 450. The four side walls 482 are fastened to the wood rim 466 of the bottom side 460, but this need not be the case. Although not shown, the exterior sides of the four side walls 482 and the top side 484 are generally covered with a thin plastic sheet to provide protection from wind, sun, and/or precipitation during transport.

An exterior of the crate 450 measures 345.4 centimeters long and 201.9 centimeters long (approximately 136 by 80 inches), with an interior space defined by the side walls 482 which is 340.9 centimeters long and 189.8 centimeters wide (approximately 134 by 75 inches) for accommodating the vehicle 10. It is contemplated that those dimensions could be different, depending on specifics of the crate 450. It should be noted that the side walls 482 are not solid and have spaces between the wooden frame members that make up the side walls 482. As such, the vehicle 10 can have portions that are wider then 189.8 centimeters and/or longer than 340.9 centimeters which extend into the spaces of the side walls 482, up to the maximum external limits of the crate 450.

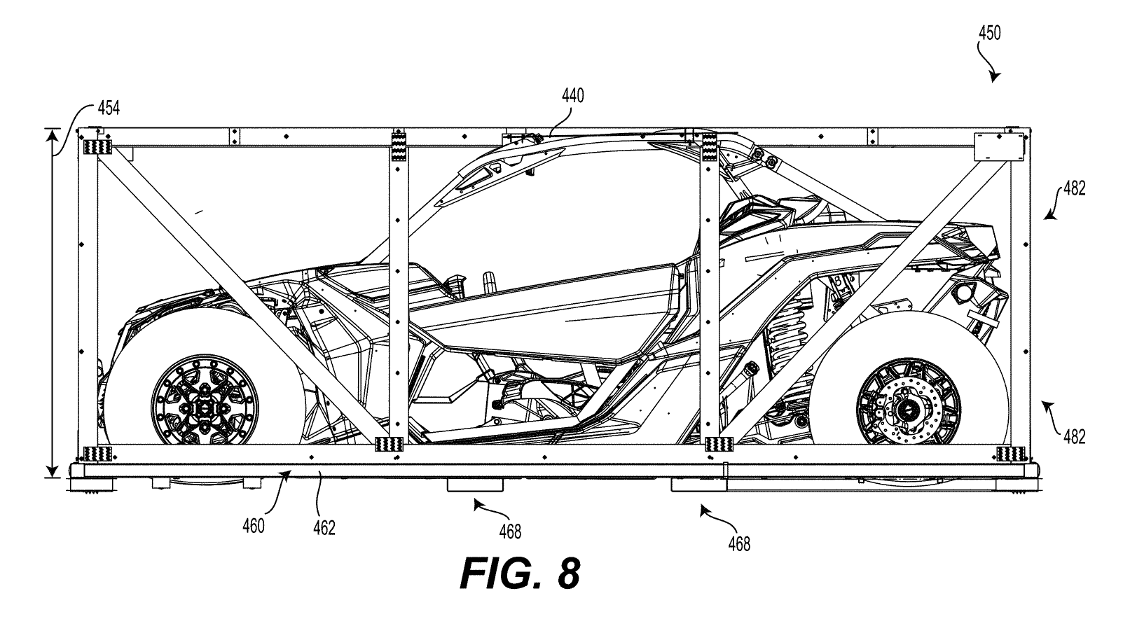

As the tubes 468 need to be 2 inches (approximately 5 centimeters) tall in order to accommodate forklift tines therein, and the crate 450 has the aforementioned maximum external height 452 of 52 inches, there remains 127 centimeters (50 inches) for the vehicle 10 and the top side 484. In this implementation, the crate 450 has a maximum internal height 454 (for packing the vehicle 10 into) of about 127 centimeters (50 inches). The maximum internal height 454 is measured from the surfaces 470 to a top edge of the top side 484. As the top side 484 is made up of several wood members that are spaced apart, portions of the vehicle 10 may pass between the members of the top side 484, as is illustrated in FIG. 8 where part of one of the side walls 482 has been removed. Thus the maximum internal height 454 extends up to the top edge of the top side 484.

The vehicle 10, when at rest and ready to use, has a full vehicle height 198 measured from the ground up to a highest point of the roll cage 106, as is illustrated in FIG. 1. In the present implementation, the full vehicle height 198 is about 157.1 centimeters (about 62 inches), although this can vary depending on the exact implementation. By comparing the full vehicle height 198 (157 cm) to the maximum internal height 454 (127 cm), it can be seen that the vehicle 10 cannot be packed into the crate 450 in a configuration where the vehicle is at its full vehicle height 198.

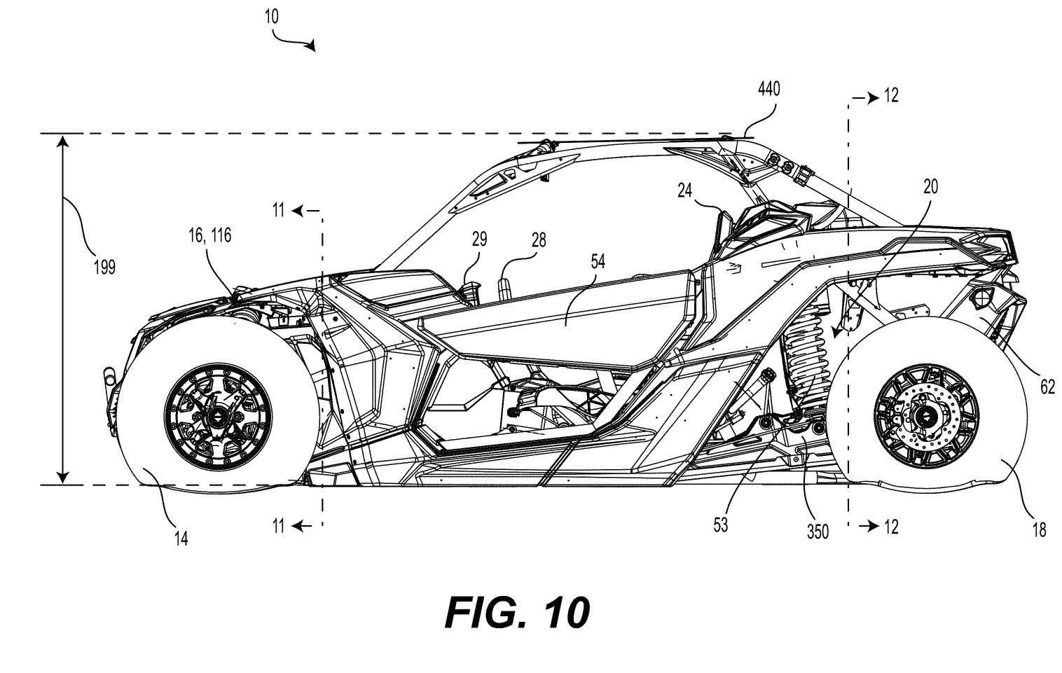

In order to pack the vehicle 10 in the crate 450 according to the present technology, the vehicle 10 is compressed into a packing configuration by compressing the front and rear suspension assemblies 16, 20. The vehicle 10 is shown in the packing configuration inside the crate 450 in FIGS. 6, 8, and 9, as well as in FIG. 10 where the crate 450 has been removed for illustration purposes. It should be noted that the height 199 from the ground to the top of the roll cage 106 of the vehicle 10 when in in the packing configuration may not necessarily be less than the maximum internal height 454 of the crate 450. As will be described in more detail below, the tires 14, 18 are placed into the apertures 464 of the bottom side 460, and a portion of the tires 14, 18 can pass below the top surface of the bottom side 460 of the crate 450.

With reference to FIGS. 9 to 13, compression of the front and rear suspension assemblies 16, 20 to bring the vehicle 10 into the packing configuration will be described in more detail. The front and rear suspension assemblies 16, 20 are compressed using four tie-down straps 400. In the present implementation, the four tie-down straps 400 are identical and all four straps 400 will be described with respect to one such tie-down strap 400. It is contemplated that the straps 400 could not be identical in some implementations.

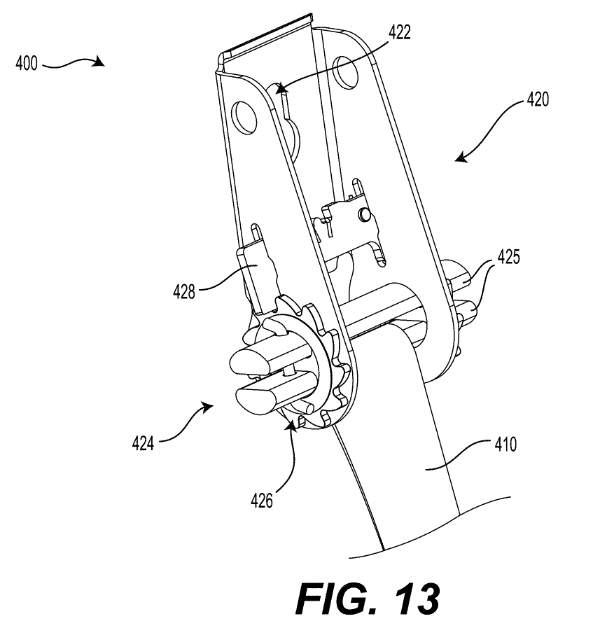

As can be seen in FIG. 13, the tie-down strap 400 includes a ratchet head 420 and a webbing 410 connected to and extending therefrom. The webbing 410 is made from flexible Polyester, but it is contemplated that the webbing 410 could be formed from other materials, including but not limited to plastic fibers, Kevlar, and nylon. A bottom end 412 of the webbing 410 includes a sewn loophole for looping the bottom end 412 around a portion of each of the suspension assemblies 16, 20, as will be described in more detail later.

In FIG. 13, the ratchet head 420 is shown in more detail. The ratchet head 420 is a metal structure for securing a top end of the tie-down strap 400 to the frame 12 of the vehicle 10. It is contemplated that the ratchet head 420 could be made of materials other than or in addition to metal, including but not limited to hardened plastic.

An aperture 422 is defined in the ratchet head 420 for anchoring the ratchet head 420 to the frame 12. As can be seen in FIGS. 4, 5, 11, and 12, the frame 12 provides four pegs 129, 221 for the purpose of attaching the ratchet heads 420 thereto. For the front suspension assemblies 16, a frame member 130 of the frame 12 includes two pegs 129, one disposed generally vertically above each of the front suspension assemblies 16. For the rear suspension assemblies 20, the frame 12 includes left and right frame members 222, each of which includes a peg 221 for attaching the ratchet head 420, each peg 221 being generally vertically above one of the rear suspension assemblies 20. The aperture 422 has a larger lower end and a narrower upper end, such that the ratchet head 420 can be passed over the pegs 129 and 221, through the larger lower end, and then secured to the pegs 129, 221 by moving the ratchet head 420 such that the peg 129, 221 is received in the narrower upper end of the aperture 422 as the narrower upper end is narrower than an outward end of the pegs 129, 221.

The ratchet head 420 includes a spool 424 for winding the webbing 410 there around to tighten the tie-down strap 400. The spool 424 is made of two portions 425 between which a top end of the webbing 410 is fastened. In some implementations, the spool 424 could be differently configured. A ratchet gear 426 is disposed around each end of the spool 424, and a pawl 428 extends through the ratchet head 420 for engaging with both ratchet gears 424. The tie-down strap 400 is tightened by winding the webbing 410 around the spool 424, the spool 424 being turned by a tool adapted to do so (not shown). The ratchet gear 426 allows the webbing 410 to be easily wound onto the spool 424 while preventing the tension on the webbing 410 from pulling the webbing 410 back out. In order to remove the tie-down straps 400, the webbing 410 can simply be cut, or the pawl 428 can be pulled upward away from the ratchet gears 426, such that the webbing 410 can freely unwind.

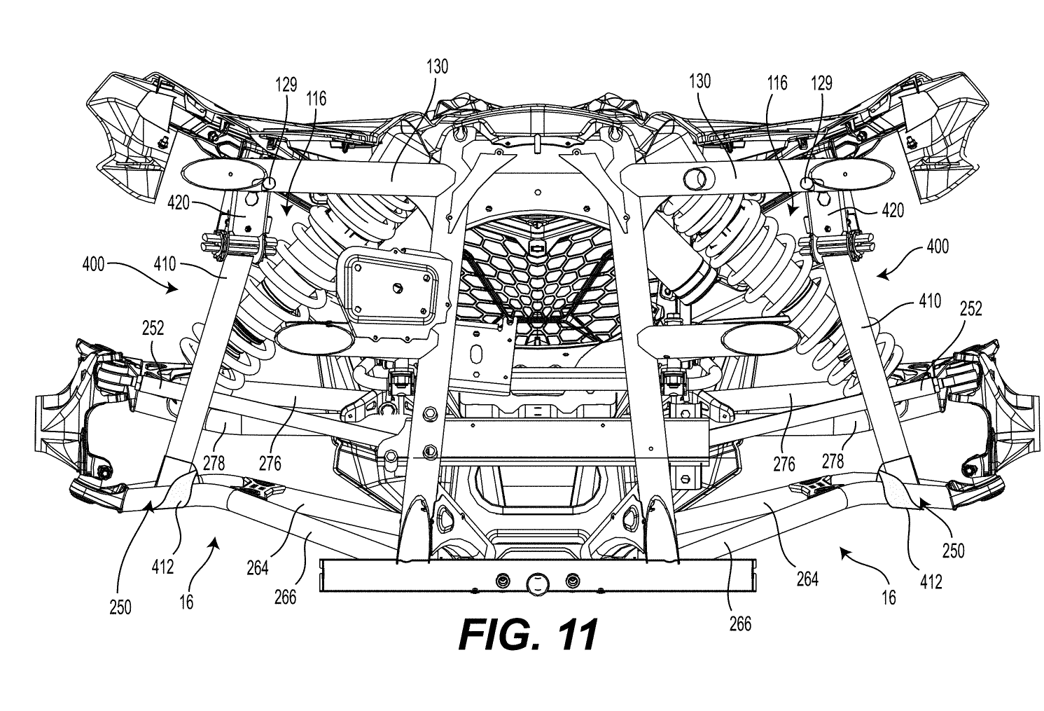

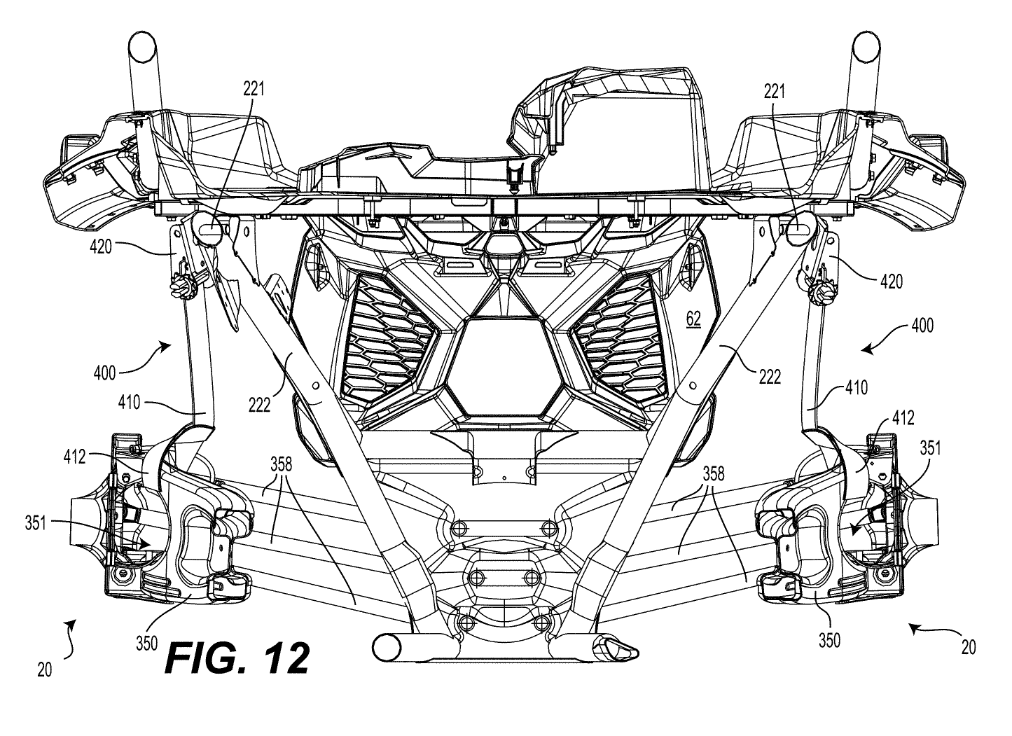

With reference to FIGS. 11 and 12, installing the tie-down straps 400 on the vehicle 10 will now be described. It should be noted that the installation and tightening of the tie-down straps 400 occurs after the vehicle 10 is placed on the bottom side 460 of the crate 450, although this may not be the case for all implementations. The tie-down straps 400 are shown as installed on the front suspension assemblies 16 in FIG. 11. For each tie-down strap 400, the bottom end 412 is looped around the rear arm 266 of the lower A-arm 250 by wrapping the bottom end 412 around the arm 266 and passing a top end of the webbing 410 through the loophole in the bottom end 412. The top end of the webbing 410 is then connected to the spool 424 of the ratchet head 420. It is contemplated that the bottom end 412 of the webbing 410 could be looped around a different arm of the lower and upper A-arms 250, 252. The ratchet head 420 is then connected to the frame member 130 of the frame 12 by hooking the aperture 422 of the ratchet head 420 onto the peg 129 at least partially vertically above the corresponding front suspension assembly 16. The tie-down straps 400 thus connected to the front suspension assemblies 16 are illustrated in FIG. 11.

The tie-down straps 400 as installed on the rear suspension assemblies 20 are shown in FIG. 12. For each tie-down strap 400, the bottom end 412 is looped around the trailing arm 350 by wrapping the bottom end 412 through an aperture 351 of the trailing arm 350 and passing the top end of the webbing 410 through the loophole in the bottom end 412. The top end of the webbing 410 is then connected to the spool 424 of the ratchet head 420. It is contemplated that the bottom end 412 of the webbing 410 could be looped around a different portion of the trailing arm 350, or a different portion of the rear suspension assembly 20. The ratchet head 420 is then connected to the frame member 222 of the frame 12 by hooking the aperture 422 of the ratchet head 420 onto the peg 221 at least partially vertically above the corresponding rear suspension assembly 16. The tie-down straps 400 thus connected to the rear suspension assemblies 16 are illustrated in FIG. 12.

Each of the four tie-down straps 400 now having been installed, the tie-down straps 400 are simply tightened until the vehicle 10 is in the packing configuration. Tightening each of the straps includes using the corresponding ratchet head 420 to wind the webbing 410 around the spool 424 using a tool for engaging the spool 424, thereby drawing the ratchet head 420 and the bottom end 412 of the webbing 410 toward each other. This compresses each suspension assembly 16, 20 and draws the vehicle body toward the wheels 14, 18. When torque measured by the tool for tightening the tie-down strap 400 reaches a pre-determined torque limit, the suspension assemblies 16, 20 are fully compressed.

The tightening of the straps 400 can be implemented in a variety of ways. In some implementations, each strap 400 can be tightened until the corresponding suspension assembly 16, 20 is sufficiently or fully compressed, before proceeding to the following tie-down strap 400. In other implementations, each of the straps 400 can be partially tightened sequentially and repeatedly such that each of the suspension assemblies 16, 20 are generally compressed together until the front and rear suspension assemblies 16, 20 are fully compressed and the vehicle 10 is in the packing configuration. In other implementations, the four straps 400 may be tightened simultaneously, for example by four people, each person tightening one of the tie-down straps 400 at the same time.

The vehicle 10 is in the packing configuration when the undercarriage of the vehicle 10 abuts the bottom side 460 of the crate 450. When the undercarriage of the vehicle 10 is abutting the surfaces 470, only a height 199 from undercarriage on the surfaces 470 to the top of the roll cage 106 (see FIG. 10) needs to be equal to or less than the maximum internal height 454 of the crate 450. In the illustrated vehicle 10, the height 199 is about 125.5 centimeters (49.4 inches) and as such the vehicle 10 can be packed into the crate 450 in the packing configuration. Further, the weight of the vehicle 10 so arranged generally rests on the surfaces 470 and not on the wheels 14, 18. As such the tires 14, 18 could, in some implementations, be deflated without risking damage to the tires on the wheels 14, 18. When the vehicle 10 is in the packing configuration, the front and rear suspension assemblies 16, 20 also abut the suspension stoppers 57, 118 of the vehicle 10.

As can be seen in FIG. 8, a protective plate 440 is also installed on the vehicle 10 during the packing process. The plate 440 is made of hardened plastic and helps to limit damage to the top side of the roll cage 106 by providing an additional layer of material between the roll cage 106 and the crate 450. It is contemplated that the protective plate 440 could be made of any of a number of different materials, depending on the implementation. The protective plate 440 is fastened to the roll cage 106 any time before the crate 450 is closed around the vehicle 10, including but not limited to: before the vehicle 10 is placed on the bottom side 460 and after the vehicle 10 is in the packing configuration. It is contemplated that the protective plate 440 may be omitted in some implementations.

Once the vehicle 10 is in the packing configuration on the bottom side 460 of the crate 450, the top most point of the roll cage 106 is at or below the top side 484 of the crate 450, as can be seen in FIG. 8. While the total height from the bottom of the wheels 14, 18 to the top of the roll cage 106 may be greater than the internal height 454, a portion of the wheels 14, 18 are actually lower than the surfaces 470. The apertures 464 allow the wheels 14, 18 to use a portion of the height of the crate 450 that is otherwise lost to the vehicle 10, as the bottom 5 cm (2 in.) is partially reserved for the tubes 468 for forklift tines. Further, as the wheels 14, 18 are slightly lower than the rest of the vehicle 10 and the suspension assemblies 16, 20 are fully compressed, the undercarriage of the vehicle 10 rests directly on the surfaces 470. In some implementations, the tires of the wheels 14, 18 could be deflated. In some implementations of the vehicle 10, for instance for slightly smaller implementations, the bottom side 460 could not include apertures for the tires; it is contemplated that in such a case the height of the vehicle 10 in the packing configuration would be less than or equal to the maximum internal height 454 of the crate 450.

The vehicle 10 is further attached to the bottom side 460 by connecting a plurality of plastic straps 467 around a portion of each of the suspension assemblies 16, 20 of the vehicle 10, through the wood rim 466 and around the steel frame 462. Two such straps 467 are illustrated in FIG. 9 where the straps 467 have been looped around two of the rear suspension links 358. Two plastic straps 467 are also looped around a portion of the front suspension assembly 16 at the front of the vehicle 10 (not shown). In some implementations, the plastic straps 467 could connect the vehicle 10 to one or more of the side walls 482. In is also contemplated that the plastic straps 467 could be omitted in some scenarios. It is also contemplated that the straps 467 could be made from different materials, including for example metal.

The vehicle 10, as placed on the bottom side 460 and in the packing configuration, can now be closed into the crate 450 by attaching the side walls 482 and the top side 484 of the crate 450. As mentioned above, the side walls 482 and the top side 484 can be assembled together first, and then connected to the bottom side 460, although this may not always be the case. As can be seen from the above, arranging the vehicle 10 in the packing configuration has not necessitated that the roll cage 106 or the wheels 14, 18 be removed from the vehicle 10. This allows, for example, the roll cage 106 to be welded to the frame 12 (as described above) instead of requiring the roll cage 106 to be removable in order to be packed in the crate 450. Both the roll cage 106 and the wheels 14, 18 are still installed on the vehicle 10, and as such will not need to be separately packaged or re-installed upon delivery.

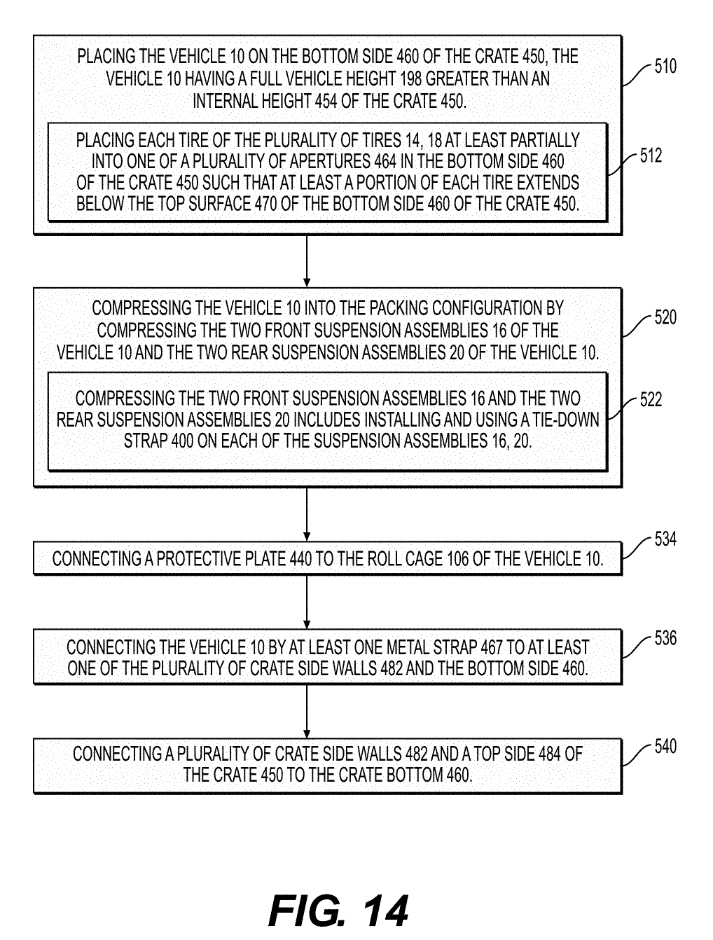

With reference to FIGS. 6 to 14, a method 500 of packing the vehicle 10 in the crate 450 for shipment will now be described. A schematic flowchart of the method 500 is illustrated in FIG. 14.

Specifically, the method 500 begins by placing the vehicle 10 on the bottom side 460 of the crate 450 at step 510. The vehicle 10 is driven, rolled, or set down onto the bottom side 460, the bottom side 460 being separate from the rest of the crate 450. The placing at step 510 includes placing, at step 512, the tires 14, 18 at least partially into the apertures 464 in the bottom side 460 of the crate 450 such that at least a portion of each tire 14, 18 extends below the top surface 470 of the bottom side 460 of the crate 450. It is contemplated that there may be more or fewer apertures and the method 500 would be adapted to place fewer or none of the tires 14, 18 into the apertures 464.

Next the method 500 continues with compressing the vehicle 10 into the packing configuration by compressing the two front suspension assemblies 16 of the vehicle 10 and two rear suspension assemblies 20 of the vehicle 10 at step 520. It is contemplated that the compressing the two front suspension assemblies 16 of the vehicle 10 and two rear suspension assemblies 20 of the vehicle 10 at step 520 could take place before the vehicle 10 is placed on the base 460 at step 510, where the compressed vehicle 10 could be lifted and placed on the base 460 in the packing configuration.

The compressing the vehicle 10 at step 520 includes installing and using one tie-down strap 400 on each of the suspension assemblies 16, 20 at step 522. For each of the front suspension assemblies 16, the connecting the tie-down strap 400 includes looping the bottom end 412 of the webbing 410 around a portion of the A-arm 250 of the corresponding front suspension assembly 16 and connecting the ratchet head 420 to the corresponding peg 129 disposed on the frame 12 at least partially vertically above the corresponding front suspension assembly 16. For each of the rear suspension assemblies 20, the connecting the tie-down strap 400 includes looping the bottom end 412 of the webbing 410 around a portion of the trailing arm 350 and connecting the ratchet head 420 to the corresponding peg 221 disposed on the frame 12 at least partially vertically above the corresponding rear suspension assembly 20. Tightening each of the tie-down straps 400 at step 522 includes using the corresponding ratchet head 420 to wind the webbing 410 around the spool 424, thereby drawing the ratchet head 420 and the bottom end 412 toward each other.

It is contemplated that one tie-down strap 400 could be used to compress both of the front suspension assemblies 16 or both rear suspension assemblies 20, where the tie-down strap 400 could be connected around, for instance, a rigid axle of the vehicle 10. In some implementations, the compressing the suspension assemblies 16, 20 at step 522 includes only partially winding the corresponding webbing 410 and then repeating the partial winding of each of the tie-down straps 400 until the front and rear suspension assemblies 16, 20 are compressed and the vehicle 10 is in the packing configuration.

The method 500 continues connecting the protective plate 440 to the roll cage 106 at step 534. It is contemplated that the protective plate 440 could be connected at step 534 at earlier points in the method 500, including but not limited to before placing the vehicle 10 on the bottom side 460 at step 510. The method 500 also includes connecting the vehicle 10 to the crate 450 by one or more plastic straps 467 by wrapping the plastic straps 467 around a portion of the vehicle 10 and the bottom side 460 at step 536. It is contemplated that the method 500 could exclude steps 534 and/or 536 in some implementations. It is contemplated that the method 500 could further include at least partially deflating at least two of the tires of the wheels 14, 18 of the vehicle 10.

Finally, the method 500 concludes with connecting a plurality of crate side walls 482 and a top side 484 of the crate 450 to the crate bottom 460 at step 540. The crate side walls 482 are placed around the wood rim 466 of the bottom side 460 and screwed thereto. The crate side walls 482 and the top side 484 are generally fastened together before joining the crate side walls 482 and the top side 484 with the bottom side 460, although it is contemplated that this may not always be the case. It is contemplated that in some scenarios that step 536 could be implemented after step 540, wherein the vehicle 10 can be further be connected to the crate 450 by one or more plastic straps 467 by wrapping the plastic straps 467 around a portion of the vehicle 10 and one or more of the side walls 482.

It is contemplated that the method 500 could include additional or different steps, either to perform additional functions and/or to perform the steps described above. It is also contemplated that the steps 520 and 522 could be performed in an assortment of different sequences, including for example before steps 510 and 512. Additionally, the steps 522, 534, and 536 could be performed in an assortment of different sequences, depending on for example user preferences, and is not limited to the order set forth in the explanation above.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of packing a vehicle in a crate for shipment, the vehicle having a full vehicle height greater than an internal height of the crate, the method comprising:
placing the vehicle on a bottom side of the crate;
compressing the vehicle into a packing configuration by compressing two front suspension assemblies of the vehicle and two rear suspension assemblies of the vehicle; and
connecting a plurality of crate side walls and a top side of the crate to the crate bottom,
the internal height being measured from a top surface of the bottom side of the crate to the top side of the crate,
a distance from the top surface of the bottom side of the crate to a highest point of a roll cage of the vehicle is less than or equal to the internal height of the crate when the vehicle is in the packing configuration and is placed on the top surface of the bottom side of the crate, the roll cage and a plurality of tires being installed on the vehicle when the vehicle is in the packing configuration.

2. The method of claim 1, wherein compressing the two front suspension assemblies and the two rear suspension assemblies includes installing and using a tie-down strap on each of the suspension assemblies.

3. The method of claim 1, wherein the compressing the two front suspension assemblies and the two rear suspension assemblies comprises:
connecting a first front tie-down strap between a first front suspension assembly of the two front suspension assemblies and a frame of the vehicle;
connecting a second front tie-down strap between a second front suspension assembly of the two front suspension assemblies and the frame of the vehicle;
connecting a first rear tie-down strap between a first rear suspension assembly of the two rear suspension assemblies and the frame of the vehicle;
connecting a second rear tie-down strap between a second rear suspension assembly of the two rear suspension assemblies and the frame of the vehicle;
tightening the first front tie-down strap to compress the first front suspension assembly;
tightening the second front tie-down strap to compress the second front suspension assembly;
tightening the first rear tie-down strap to compress the first rear suspension assembly; and
tightening the second rear tie-down strap to compress the second rear suspension assembly.

4. The method of claim 3, wherein:
for the first front tie-down strap and the second front tie-down strap, the connecting the tie-down strap comprises:
looping a bottom end of a webbing of the tie-down strap around a portion of an A-arm of the corresponding front suspension assembly, and
connecting a ratchet head of the tie-down strap to a corresponding one of a first front peg and a second front peg disposed on the frame of the vehicle at least partially vertically above the corresponding front suspension assembly;
for the first rear tie-down strap and the second rear tie-down strap, the connecting the tie-down strap comprises:
looping a bottom end of a webbing of the tie-down strap around a portion of a trailing arm of the corresponding rear suspension assembly, and
connecting a ratchet head of the tie-down strap to a corresponding one of a first rear peg and a second rear peg disposed on the frame of the vehicle at least partially vertically above the corresponding rear suspension assembly; and
tightening each of the first front tie-down strap, second front tie-down strap, first rear tie-down strap, and second rear tie-down strap includes using the corresponding ratchet head to wind the webbing around a spool of the ratchet head, thereby drawing the ratchet head and the bottom end toward each other.

5. The method of claim 3, wherein:
the tightening of the first front tie-down strap, second front tie-down strap, first rear tie-down strap, and second rear tie-down strap includes only partially winding the corresponding webbing; and
the method further comprises:
repeating the partial winding of the first front tie-down strap, second front tie-down strap, first rear tie-down strap, and second rear tie-down strap until the front and rear suspension assemblies are compressed and the vehicle is in the packing configuration.

6. The method of claim 1, wherein an undercarriage of the vehicle abuts the bottom side of the crate when the front suspension assemblies and the rear suspension assemblies are compressed and the vehicle is in the packing configuration.

7. The method of claim 1, wherein the vehicle is in the packing configuration when the front and rear suspension assemblies abut a plurality of suspension stoppers of the vehicle.

8. The method of claim 1, further comprising connecting a protective plate to the roll cage of the vehicle.

9. The method of claim 1, further comprising connecting the vehicle by at least one strap to at least one of:
the plurality of crate side walls; and
the bottom side of the crate.

10. The method of claim 1, wherein:
an exterior height of the crate is about 52 inches; and
the distance from the top surface of the bottom side of the crate to the highest point of the roll cage of the vehicle is equal to or less than 50 inches.

11. The method of claim 1, wherein an exterior height of the crate is less than or equal to half of a pre-determined maximum shipping height.

12. The method of claim 1, wherein, when the vehicle is in the packing configuration, the roll cage and the plurality of tires are connected to the vehicle in their operational arrangement.

13. The method of claim 1, wherein the placing the vehicle on a bottom side of the crate includes placing at least one tire of the plurality of tires partially into at least one aperture in the bottom side of the crate such that at least a portion of the at least one tire extends below the top surface of the bottom side of the crate.

14. The method of claim 1, wherein the placing the vehicle on a bottom side of the crate includes placing each tire of the plurality of tires at least partially into one of a plurality of apertures in the bottom side of the crate such that at least a portion of each tire extends below the top surface of the bottom side of the crate.
